(19) United States
(12) Patent Application Publication
(10) Pub. No.: US 2017/0224578 A1
(43) Pub. Date: Aug. 10, 2017

(54) Therapeutic Massager for Managing Swelling and Pain

(71) Applicant: Brian Beesley, Martinsville, IN (US)

(72) Inventor: Brian Beesley, Martinsville, IN (US)

(21) Appl. No.: 15/425,442

(22) Filed: Feb. 6, 2017

Related U.S. Application Data
(60) Provisional application No. 62/291,927, filed on Feb. 5, 2016.

(51) Int. Cl. A61H 15/02; A61H 15/00

(52) U.S. Cl. CPC A61H 15/02; A61H 15/0092; A61H 2015/0014; A61H 2205/12; A61H 2201/0214

(57) ABSTRACT

An apparatus and method for managing pain and swelling in foot using a roller.

### CROSS REFERENCE TO RELATED APPLICATION

The present application claims the benefit of U.S. Provisional Patent Application No. 62/291,927, entitled “Therapeutic Massager for Managing Swelling and Pain,” to Brian J. Beesley, filed on Feb. 5, 2016, which is hereby incorporated by reference in its entirety.

### FIELD OF THE DISCLOSURE

The disclosure relates to a method for managing pain and swelling in the foot using a roller.

### BACKGROUND OF THE DISCLOSURE

Painful feet caused by foot pathology can interfere with a person's mobility and their enjoyment of everyday activities. While devices exist with the goal of treating foot pathologies, most lack the proper support and fail to provide enough relief to satisfy a user's desire and needs.

One common method of treating foot disorders involves rolling a user's foot over a frozen water bottle. The use of a water bottle limits direct physical contact between the foot and the bottle because of the shallowness of the ridges and the awkward contours of the bottle.

### SUMMARY OF THE DISCLOSURE

The present disclosure relates to an apparatus and a method using a cold cylindrical roller for the management and/or reduction of foot pain through physical contact. The disclosed roller may include features such as ridges and varying configurations to cater to the demand of the user. The roller may be made of metals or other materials to aid durability and thermal conductivity upon contact with a bare foot.

In some embodiments, the method for relieving pain comprises rolling the foot of a user on a cylindrical roller where the outer surface contains a plurality of ridges or groves to increase direct contact. This facilitates direct contact by pinpointing the source of pain on the contour of the bottom of the user's foot.

In some embodiments, the cross-sectional surface area of the cylindrical roller may be larger or smaller than others so as to achieve adequate support based on the proportion to the user's foot size.

In some embodiments, the roller may be placed in an insulating sleeve that has a lower thermal conductivity than the cylindrical metal roller prior to contact with the user's foot to prevent the user's skin from sticking to the roller.

### BRIEF DESCRIPTION OF THE DRAWINGS

FIG. 1 is a side view of roller for use with a user's foot;

FIG. 2 is a side view of an embodiment of another roller having an overall smaller surface area than the roller of FIG. 1;

FIG. 3 is a side view of another embodiment of a roller comprising a ridge in the middle of the roller as well as two ends that have the same overall diameter as that of the middle ridge;

FIG. 4 is a cross sectional view of the roller of FIG. 3 taken along line 4-4 of FIG. 3;

FIG. 5 is a perspective view of the roller of FIG. 1 positioned inside a freeze before use;

FIG. 6 is a view of the roller (shown in phantom) in FIG. 1 placed in an insulating sleeve; and

FIG. 6 is a view of the roller (shown in phantom) in FIG. 1 placed in an insulating sleeve; and

FIG. 7 is a view of alternative embodiment rollers showing a roller on the right hand side having sinusoidal ridges and a roller on the left hand size having sinusoidal ridges spaced closer together than the ridges on the right hand side.

For the purposes of promoting an understanding of the principals of the disclosure, reference will now be made to the embodiments illustrated in the drawings, which are described below. The embodiments disclosed below are not intended to be exhaustive or limit the disclosure to the precise form disclosed in the following detailed description. Rather, the embodiments are chosen and described so that others skilled in the art may utilize their teachings. It will be understood that no limitation of the scope of the disclosure is thereby intended. The disclosure includes any alterations and further modifications in the illustrative devices and described methods and further applications of the principles of the disclosure which would normally occur to one skilled in the art to which the disclosure relates.

### DETAILED DESCRIPTION OF THE DRAWINGS

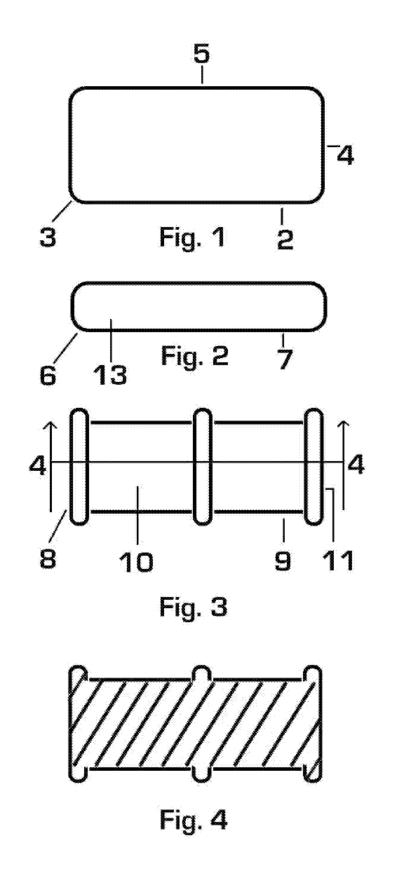

Referring to FIG. 1, an embodiment of a therapeutic massager for pain management and swelling control is shown. The apparatus comprises a cylindrical shaped roller 2 with rounded edges 3 between a cylindrical surface 5 and vertical circular surfaces 4. Roller 2 may be made of solid or hollow metals, such as copper, aluminum, or other metals or other materials capable of aiding durability while having high thermal conductivity. Roller 2 is preferably has a radius of about 1 inch and is about 6.5 inches long. According to alternative embodiments, other radii are provided such as 0.5, 0.75, 1.25, 1.5, 2.0, etc. inches.

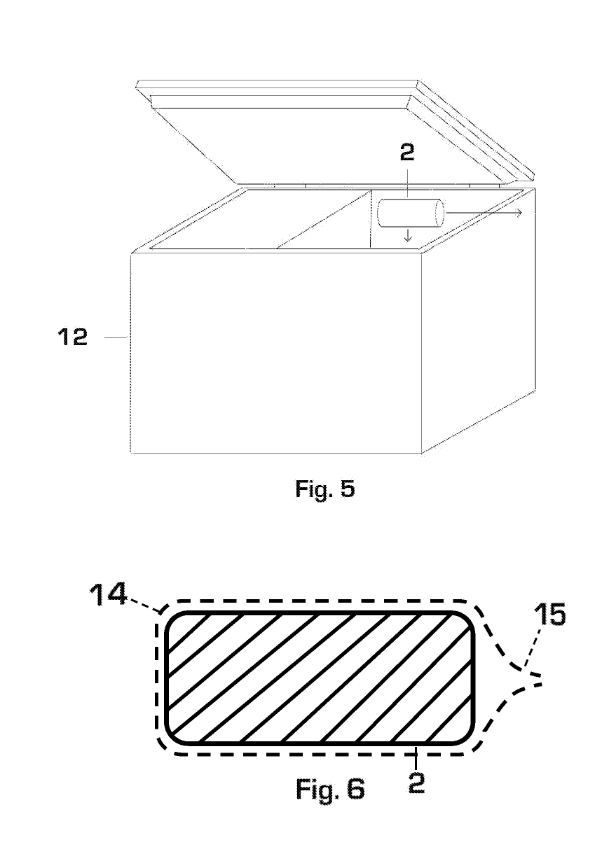

Referring to FIG. 5, before use roller 2 is placed inside a freezer 12. Upon freezing at least below the freezing point of water (i.e. below 32° F.), roller 2 is removed from freezer 12 and positioned on the floor so a user can roll roller 2 under their foot to be treated. Applying roller 2 in direct contact with the user's foot reduces pain and swelling by constricting blood flow thereby slowing blood circulation. Eventually, roller 2 will warm up and need to be placed back into freezer 12. Once frozen (or otherwise suitably cold), roller 2 can be removed from freezer 12 and used by a user again. The freezing and use of roller 2 can be repeated as desired by the user or otherwise.

Referring to FIG. 2, one embodiment of another therapeutic roller 7 is shown. Roller 7 is cylindrically shaped with rounded edges 6. Surface area 13 of roller 7 may be smaller or larger than depicted in FIG. 1 to meet the demand of the user.

Referring to FIG. 3, another alternative embodiment of a therapeutic roller 9 is shown. Roller 9 includes multiple ridges 8 along an outer surface 10 of roller 9. Ridges 8 may vary in diameter with respect to vertical ends 11 to facilitate direct contact between roller 9 and user's foot.

FIG. 4 is a cross sectional view of roller 9 of FIG. 3 taken along line 4-4 of FIG. 3. The solid one-piece structure allows for increase in thermal capacity resulting in extended use of roller 9 under room temperature before needing to be placed back in the freezer to be cooled.

Referring to FIG. 6, roller 2 is shown inside of an insulating sleeve 14 (in phantom) that has a lower thermal conductivity than the cylindrical metal roller 2. An open end 15 of insulating sleeve 14 is shown in the cinched position. Placing roller 2 in insulating sleeve 14 helps avoid the user's foot from sticking to roller 2 after roller 2 has been chilled.

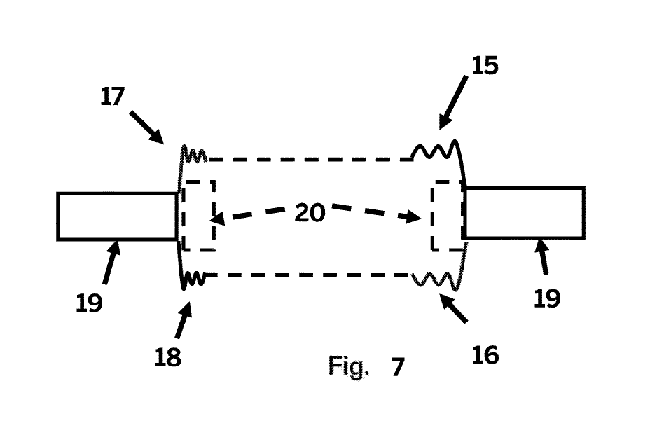

Referring to FIG. 7, a right end of roller 15 is shown having a plurality of ridges 16 forming a sinusoidal pattern. Ridges 16 extend from the right end to a left end (not shown) of roller 15. A left end of roller 17 is shown having a plurality of ridges 18 forming a sinusoidal pattern. Ridges 18 extend from the left end to a right end (not shown) of roller 17. Rollers 15, 17 have cylindrical handles 19 and bearings 20 (in phantom) that allow a user to grasps handles 19 and roll rollers 15, 17 over a portion of the user's body, such as a thigh, etc. Bearings 20 allow rollers 15, 17 to rotate relative to handles 19. Handles 19 are removable from rollers 15, 17. During freezing of rollers 15, 17, handles 19 may be removed so that handles 19 are not frozen. Thus, during use, handles 19 are not cold, but are at room temperature.

What is claimed is:

1. A method of managing and reducing foot pain using a cylindrical shaped metal roller, the method comprising the steps of
placing the cylindrical shaped metal roller in a freezer until the cylindrical shaped metal roller maintains a temperature at or below the freezing point of water,
removing the cylindrical shaped metal roller from the freezer,
placing the cylindrical shaped metal roller on a surface,
rolling the bottom of the user's foot back and forth over a cylindrical surface of the cylindrical shaped metal roller, and
placing the cylindrical shaped metal roller back in a freezer to restore the cylindrical shaped metal roller to a temperature at or below the freezing point of water.

2. The method of claim 1, wherein the cylindrical shaped metal roller has a cylindrically-shaped body portion with a plurality of ridges.

3. The method of claim 1, further comprising the step of placing an insulating sleeve over the cylindrical shaped metal roller.

4. The method of claim 3, wherein the insulating sleeve of claim 3 has an open end and a closed end.

5. The method of claim 4, further comprising the step of opening the open end of the insulating sleeve and inserting the cylindrical shaped metal roller into the open end.

6. The method of claim 5, further comprising the step of cinching closed the open end of the insulating sleeve.

7. The method of claim 1, wherein the user's foot is in direct contact with the cylindrical surface of the cylindrically shaped metal roller during the rolling step.
